(19) United States
(12) Patent Application Publication
(10) Pub. No.: US 2026/0182600 A1
(43) Pub. Date: Jul. 2, 2026

(54) Cocoa Butter Infused with Freeze-Dried Fruit Powder Using a Melanger

(71) Applicant: Mathew Ronald Martin, San Antonio, TX (US)

(72) Inventor: Mathew Ronald Martin, San Antonio, TX (US)

(21) Appl. No.: 19/003,127

(22) Filed: Dec. 27, 2024

(51) Int. Cl. A23G 1/48

(52) U.S. Cl. CPC A23G 1/48

(57) ABSTRACT

The present invention relates to a method for producing cocoa butter infused with freeze-dried fruit powder using a melanger. The method ensures homogeneous integration of fruit powder into cocoa butter, enhancing flavor, color, and nutritional benefits while maintaining a smooth and creamy texture. The use of a melanger enables uniform particle size reduction and dispersion of the fruit powder, resulting in a versatile product suitable for culinary, cosmetic, and functional applications.

### BACKGROUND OF THE INVENTION

Cocoa butter is a widely used ingredient in various industries, prized for its smooth texture, stability, and wide applicability. When combined with freeze-dried fruit powders, cocoa butter can be enhanced by introducing new flavors, vibrant colors, and additional nutritional benefits.

However, traditional methods of blending cocoa butter with fruit powders face challenges due to the hydrophobic nature of cocoa butter and the hydrophilic nature of fruit powders, resulting in poor integration and uneven distribution.

The introduction of a melanger addresses these issues by efficiently reducing the particle size of the fruit powder and ensuring consistent dispersion throughout the cocoa butter, all while maintaining the beneficial properties of both the cocoa butter and the fruit powder. This invention provides an effective solution to these challenges, offering a method that produces a high-quality infused product with improved texture, nutritional retention, and versatility.

### SUMMARY OF THE INVENTION

The invention provides a method for producing cocoa butter infused with freeze-dried fruit powder using a melanger, comprising the following steps:

### Preparation of Ingredients:

a. Cocoa butter is melted to an optimal working temperature.
b. Freeze-dried fruit powder is prepared with a fine particle size for effective blending.

### Melanger Processing:

a. The melted cocoa butter is introduced into the melanger.
b. The freeze-dried fruit powder is gradually added to the running melanger.
c. The melanger's grinding stones or rollers refine the mixture to ensure even distribution and smooth texture.

### Cooling and Storage:

a. The infused mixture is removed from the melanger, cooled under controlled conditions, and stored for use in various applications.

This method ensures that the natural nutrients, antioxidants, and vibrant colors of the fruit powder are retained, while also creating a stable, homogeneous product with enhanced sensory qualities.

### DETAILED DESCRIPTION OF THE INVENTION

### Ingredients

Cocoa Butter: Food-grade cocoa butter, melted to a temperature of 32-35° C., ensuring optimal flow and consistency.
Freeze-Dried Fruit Powder: Freeze-dried fruit powder such as strawberry, raspberry, blueberry, mango, or other fruits, ground to a fine particle size of 50 microns or smaller to ensure efficient integration with the cocoa butter.

### Process Steps

### Ingredient Preparation:

a. Cocoa butter is melted in a controlled-temperature environment, reaching a temperature of 32-35° C. This temperature is optimal for maintaining the integrity of the cocoa butter while ensuring it flows evenly.
b. Freeze-dried fruit powder is ground to a fine consistency, ideally to a particle size of 50 microns or less, ensuring effective blending.

### Melanger Infusion:

a. The melted cocoa butter is poured into the melanger, which is then activated.
b. The freeze-dried fruit powder is gradually introduced into the running melanger, which continuously grinds and refines the mixture using its grinding stones or rollers.
c. The melanger is operated for 2 to 6 hours, depending on the desired texture and degree of integration. During this time, the fruit powder is uniformly distributed within the cocoa butter.

### Cooling and Solidification:

a. After the infusion process is complete, the cocoa butter and fruit powder mixture is removed from the melanger.
b. The infused mixture is poured into molds or containers and allowed to cool gradually under controlled conditions, ensuring that the fruit powder remains evenly distributed throughout the cocoa butter as it solidifies.

### Key Benefits:

a. Nutritional Retention: The method preserves the antioxidants, vitamins, and bioactive compounds present in the freeze-dried fruit powder, ensuring the infused product retains the full nutritional value of the fruit.
b. Enhanced Texture: The use of the melanger ensures the production of a smooth, creamy texture, free from clumps or uneven distribution.
c. Customizable: The process allows for the use of a variety of freeze-dried fruit powders, enabling the creation of a wide range of unique flavors and colors suitable for various applications.

### Applications:

a. Culinary: The infused cocoa butter is ideal for use in high-end chocolates, spreads, and gourmet dessert toppings.
b. Cosmetics: The infused cocoa butter is suitable for use in cosmetic products such as lip balms, body butters, lotions, and other skincare formulations enriched with fruit extracts.
c. Health Products: The infused cocoa butter can be used in the production of nutritional bars, functional foods, and dietary supplements enriched with antioxidants and other bioactive compounds.

1. A method for producing cocoa butter infused with freeze-dried fruit powder comprising:
a. Melting cocoa butter at a temperature of 32-35° C.;
b. Adding freeze-dried fruit powder to the melted cocoa butter in a melanger;
c. Operating the melanger for 2-6 hours to achieve a uniform mixture;
d. Cooling the resulting mixture to form a solidified, evenly infused product.

2. The method of claim 1, wherein the freeze-dried fruit powder is selected from the group consisting of strawberry, raspberry, blueberry, mango, and combinations thereof.

3. The method of claim 1, wherein the melanger's refining process reduces the particle size of the freeze-dried fruit powder to 20 microns or less, thereby resulting in a smooth and creamy texture.

4. The method of claim 1, wherein the infused cocoa butter retains at least 90% of the antioxidants and bioactive compounds originally present in the freeze-dried fruit powder.

5. A functional food or cosmetic product comprising the cocoa butter infused with freeze-dried fruit powder produced by the method of claim 1.
